(19) United States
(12) Patent Application Publication
(10) Pub. No.: US 2015/0300596 A1
(43) Pub. Date: Oct. 22, 2015

(54) Light Emitting Device and an Optical Element Used Therein

(71) Applicant: Genius Electronic Optical Co., Ltd., Taichung City (TW)

(72) Inventor: Yi-Jie Lin, Taichung City (TW)

(21) Appl. No.: 14/340,256

(22) Filed: Jul. 24, 2014

(30) Foreign Application Priority Data
Apr. 21, 2014 (TW) 103114357

(51) Int. Cl. F21V 5/04; F21V 19/00; F21V 17/00; F21K 99/00

(52) U.S. Cl. CPC F21V 5/048; F21K 9/50; F21V 19/004; F21V 17/00; F21Y 2101/02

(57) ABSTRACT

A light emitting device includes a lamp holder, a light emitting unit which is removably disposed on the lamp holder and includes a plurality of light emitting elements arranged in a closed configuration, and an optical element with a lens portion and a connecting portion and removably disposed on the lamp holder. The lens portion is formed in a closed configuration which is the same as the closed configuration formed by the light emitting elements, and the lens portion is aligned with the light emitting elements. The optical element can be removed via the connecting portion, then the light emitting unit is removed from another end of the elastic clamping unit, so that the light emitting unit can be easily replaced or removed. Besides, the light emitting unit can always fit in the same optical element no matter how the number of the light emitting element changes.

### CROSS REFERENCE TO RELATED INVENTION

This application claims the benefit of priority to TW 103114357, filed on Apr. 21, 2014 with the Intellectual Property Office of the Republic of China, Taiwan, the specification of which is hereby incorporated in its entirety by reference.

### BACKGROUND OF THE INVENTION

1. Field of the Invention

The present invention relates to a light emitting device and an optical element used therein.

2. Description of the Prior Art

A conventional LED (light emitting diode) lamp 10, as shown in FIG. 1, essentially comprises a housing 11, a light emitting unit 12 and a cover 13. The light emitting unit 12 is disposed in the housing 11, and then the housing 11 is sealed with the cover 13.

The light emitting unit 12 includes a plurality of light emitting diodes 122 disposed on a circuit board 121 in a matrix manner. Each of the light emitting diodes 122 is provided with a lens 123. This light emitting unit 12 is complicated in structure, which is not suitable for mass production. When the number of light emitting diodes 122 needs to be changed, all the positions and numbers of the light emitting diodes 122 and the lenses 123 must be adjusted accordingly, which is very troublesome. If the lens 123 and the light emitting diode 122 are integral with another other as a unitary structure to make the assembly easier, the quantity and arrangement of the light emitting diodes 122, however, will be restricted, which consequently reduces the applicability and flexibility of the LED lamp.

The present invention has arisen to mitigate and/or obviate the afore-described disadvantages.

### SUMMARY OF THE INVENTION

The primary objective of the present invention is to provide a light emitting device and an optical element used therein, wherein the quantity of the light emitting elements can be adjusted easily without adjusting the number or position of other components of the light emitting device.

To achieve the above objective, a light emitting device in accordance with the present invention comprises:

a lamp holder;

a light emitting unit removably disposed on the lamp holder, and including a plurality of light emitting elements disposed on a circuit board and arranged in a closed configuration;

an optical element with a lens portion and a connecting portion and removably disposed on the lamp holder, the lens portion being formed in a closed configuration which is the same as the closed configuration formed by the light emitting elements, and the lens portion being aligned with the light emitting elements.

To achieve the above objective, an optical element used in a light emitting device in accordance with the present invention comprises a lens portion and a connecting portion, and the lens portion is formed in a closed configuration.

The optical element can be easily removed via the connecting portion, then the light emitting unit can be removed from another end of the elastic clamping unit, so that the light emitting unit can be easily replaced or removed. Besides, the light emitting unit can always fit in the same optical element no matter how the number of the light emitting element changes, since the configuration in which the light emitting elements are arranged is the same as the shape of the lens portion of the optical element.

### BRIEF DESCRIPTION OF THE DRAWINGS

FIG. 1 is an exploded view of a conventional LED lamp;

FIG. 2 is a perspective view of a light emitting device in accordance with the present invention;

FIG. 3 is another perspective view of the light emitting device in accordance with the present invention;

FIG. 4 is an exploded view of the light emitting device in accordance with the present invention;

FIG. 5 is a cross sectional view of an optical element used in the light emitting device in accordance with the present invention;

FIG. 6 is another cross sectional view of an optical element used in the light emitting device in accordance with the present invention;

FIG. 7 is a plan view of the light emitting device in accordance with the present invention;

FIG. 8 is a plan view of the light emitting device in accordance with the present invention, wherein the light emitting elements are arranged in a square configuration;

FIG. 9 is a plan view of the light emitting device in accordance with the present invention, wherein the light emitting elements are arranged in the configuration of a closed track;

FIG. 10 is a plan view of the light emitting device in accordance with the present invention, wherein the light emitting elements are arranged in the configuration of a concaved lens;

FIG. 11 is a plan view of the light emitting device in accordance with the present invention, wherein the light emitting elements are arranged in a triangle configuration;

FIG. 12 is a plan view of the light emitting device in accordance with the present invention, wherein the light emitting elements are arranged in an elliptical configuration; and

FIG. 13 is a plan view of the light emitting device in accordance with the present invention, wherein the light emitting elements are arranged in the configuration of a curved circle.

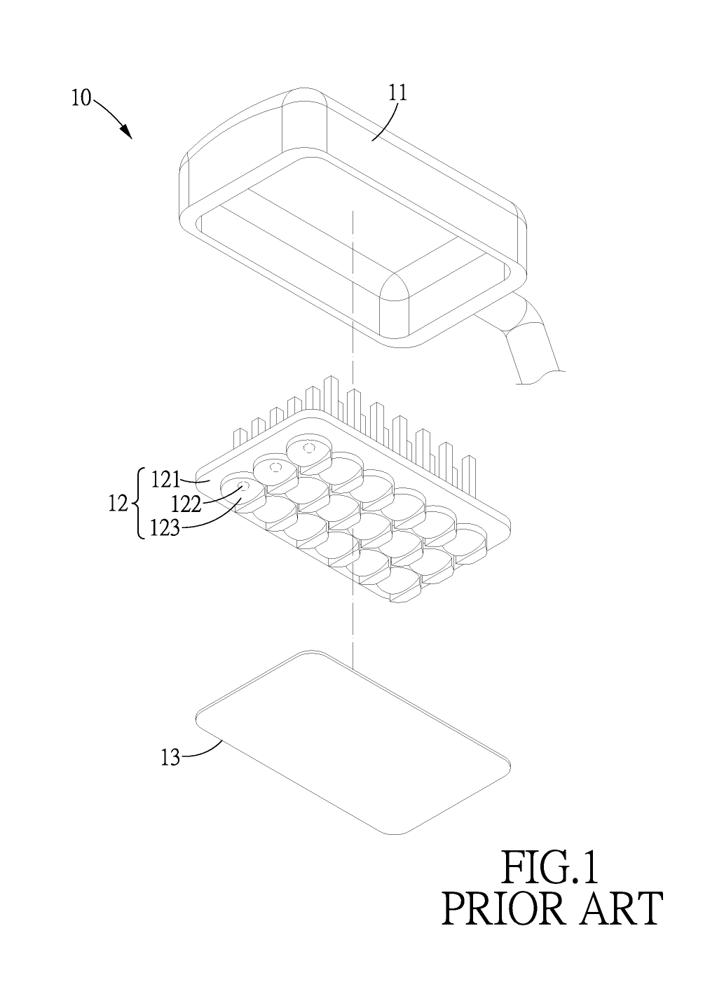

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

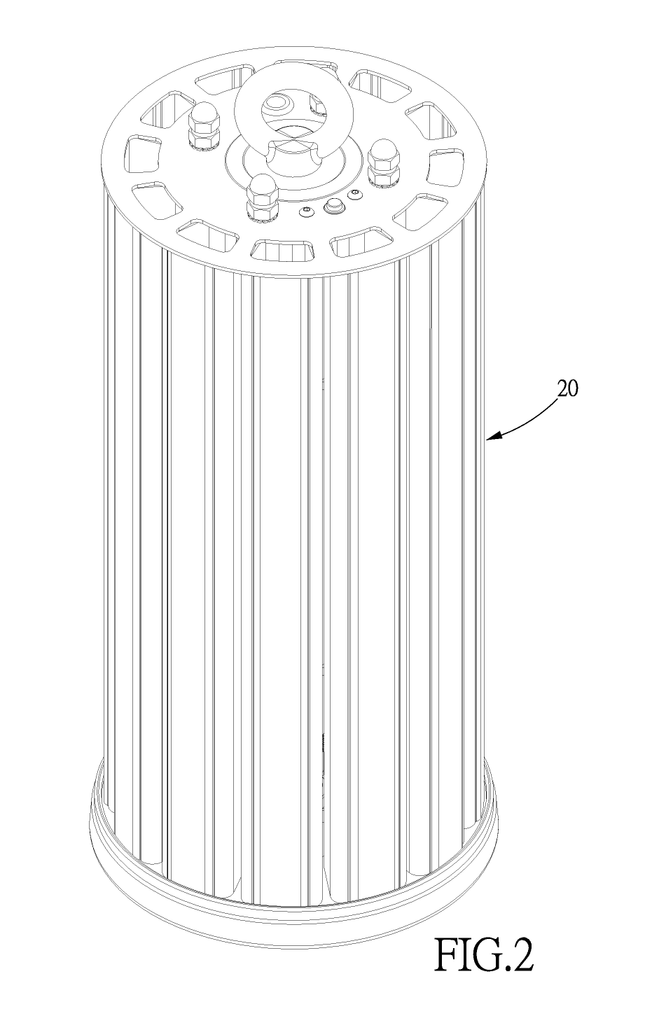

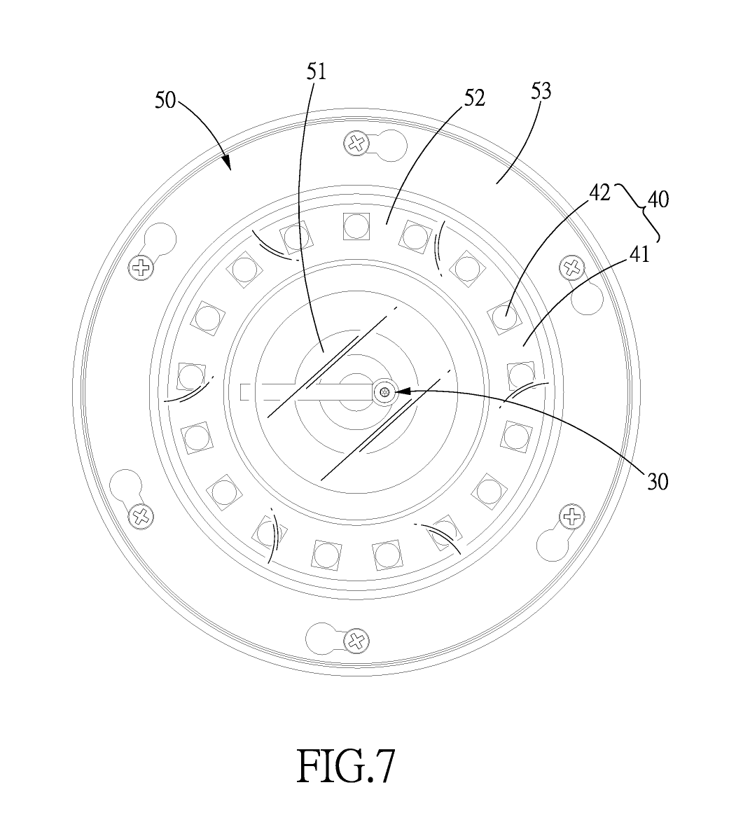

Referring to FIGS. 2-13, a light emitting device and an optical element used therein in accordance with a preferred embodiment of the present invention comprises: a lamp holder 20, an elastic clamping unit 30, a light emitting unit 40, and the optical element 50.

The elastic clamping unit 30 is disposed on the lamp holder 20 and has one end fixed to the lamp holder 20, and another elastically pressed against the lamp holder 20.

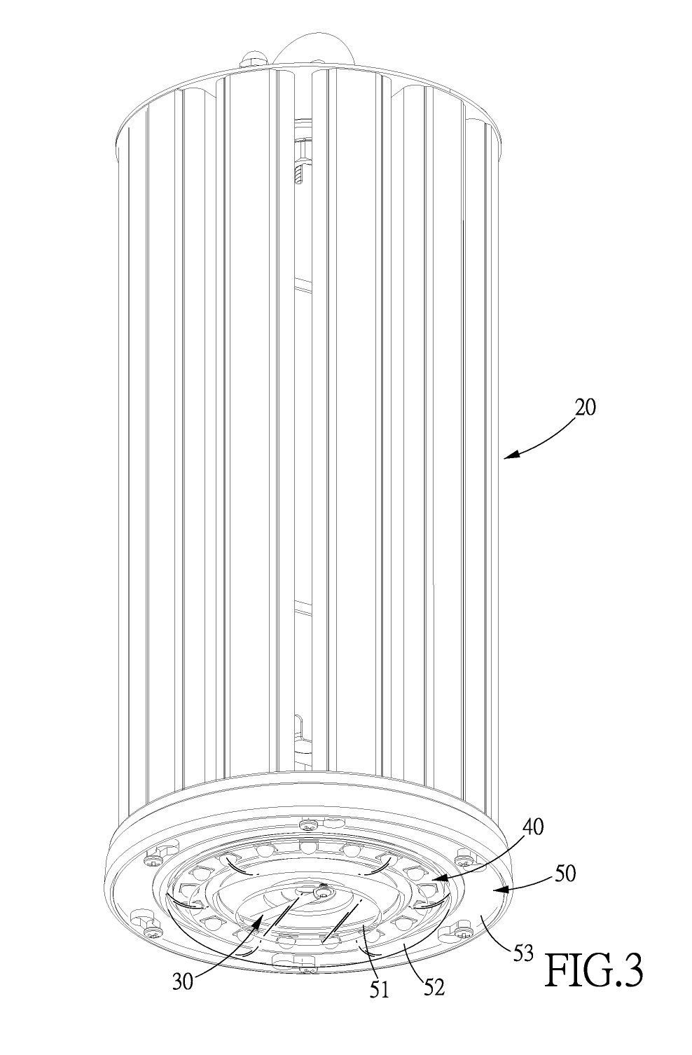

The light emitting unit 40 is removably disposed on the lamp holder 20, and comprises: a plurality of light emitting elements 42 disposed on a circuit board 41 and arranged in a closed configuration. The closed configuration is defined in physical terms, but also means the closure defined by Gesetz der Geschlossenheit. These light emitting elements 42 can be arranged to form a closed configuration in a spaced apart manner or in a manner that the light emitting elements 42 are seamlessly connected to one another. In this embodiment, the light emitting elements 42 are annularly arranged in a circle configuration, as shown in FIGS. 3, 4 and 7. The circuit board 41 of the light emitting unit 40 includes a hole 411, and the elastic clamping unit 30 has its another end passed through the hole 411 and elastically pressed against the circuit board 41, so as to fix the circuit board 41 to the lamp holder 20.

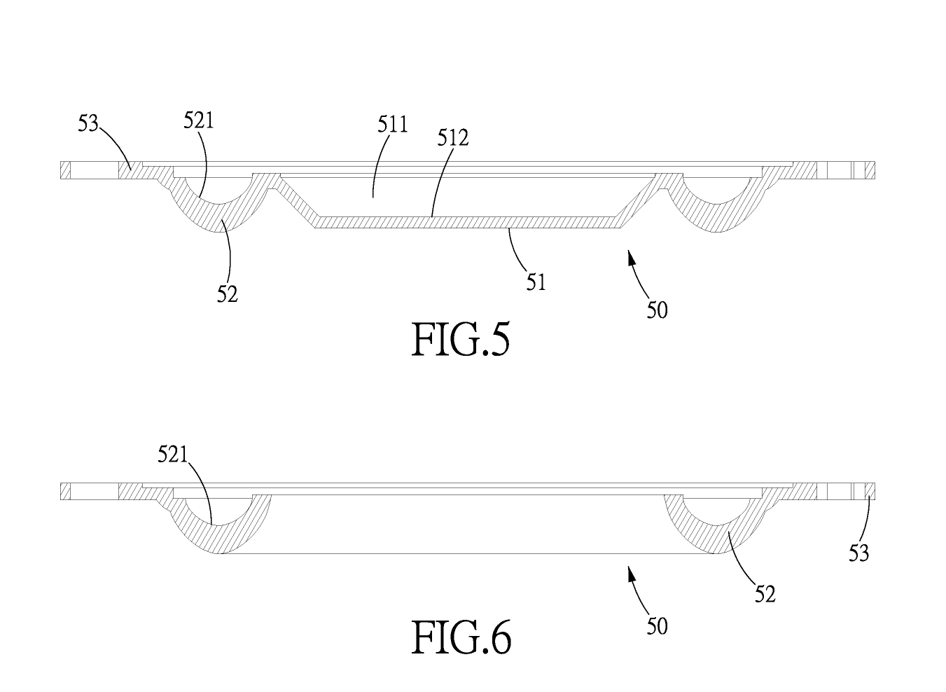

The optical element 50 includes a cover portion 51, a lens portion 52 and a connecting portion 53. The cover portion 51 is a circular structure with an inner space 511 and an inner surface 512. The inner surface 512 is a flat surface. The lens portion 52 is formed around the periphery of the cover portion 51 in a closed configuration which is the same as the closed configuration formed by the light emitting elements 42. In this embodiment, the lens portion 52 is formed around the periphery of the cover portion 51 in a closed configuration and has an arc-shaped inner surface 521. The connecting portion 53 of the optical element 50 is removably mounted on the lamp holder 20, in a manner that the elastic clamping unit 30 is received in the inner space 511 of the optical element 50, the lens portion 52 is aligned with the light emitting elements 42, and the arc-shaped inner surface 521 of the lens portion 52 is located toward the light emitting elements 42. The light emitting unit 40 can also be fixed to the lamp holder 20 by other means in addition to the elastic clamping unit 30. The optical element 50 can also be provided with no cover portion 51, as shown in FIG. 5.

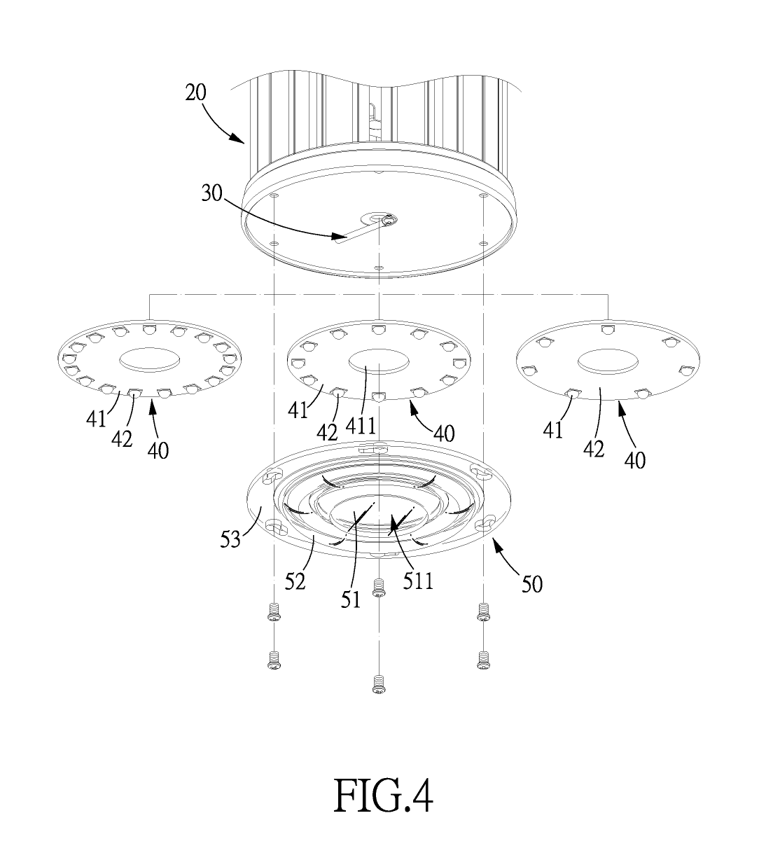

As shown in FIGS. 2 and 3, the lamp holder 20 is used on a suspending lamp, and the number of light emitting elements 42 in the light emitting unit 40 can be adjusted to meet different requirements, as shown in FIG. 4.

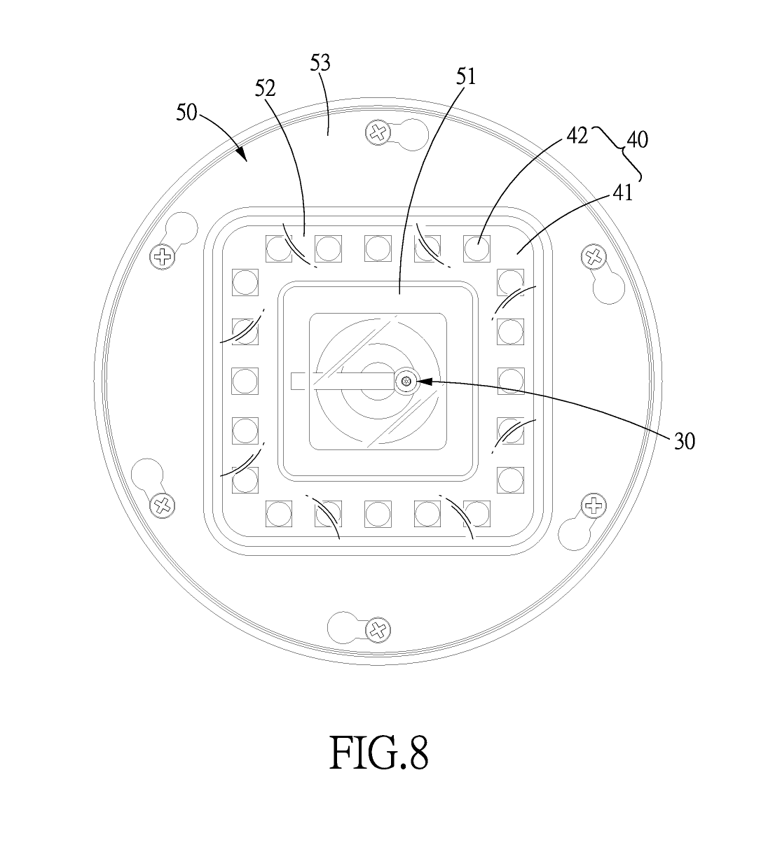

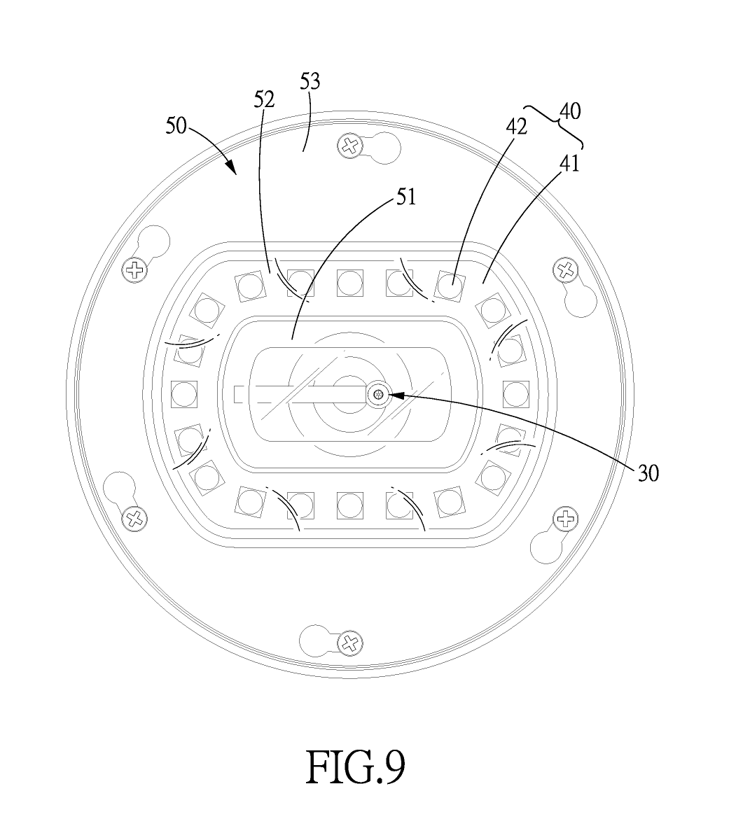

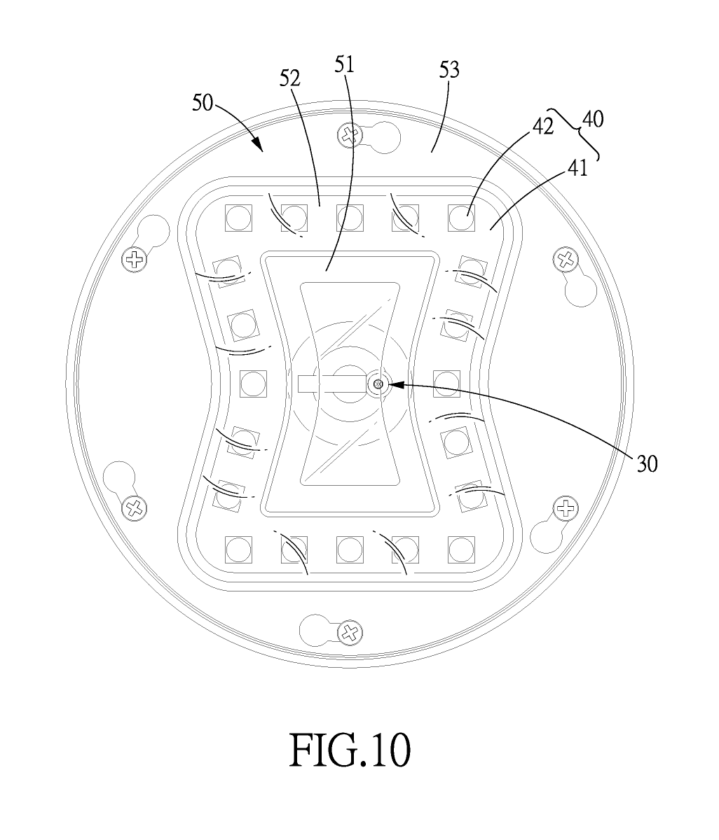

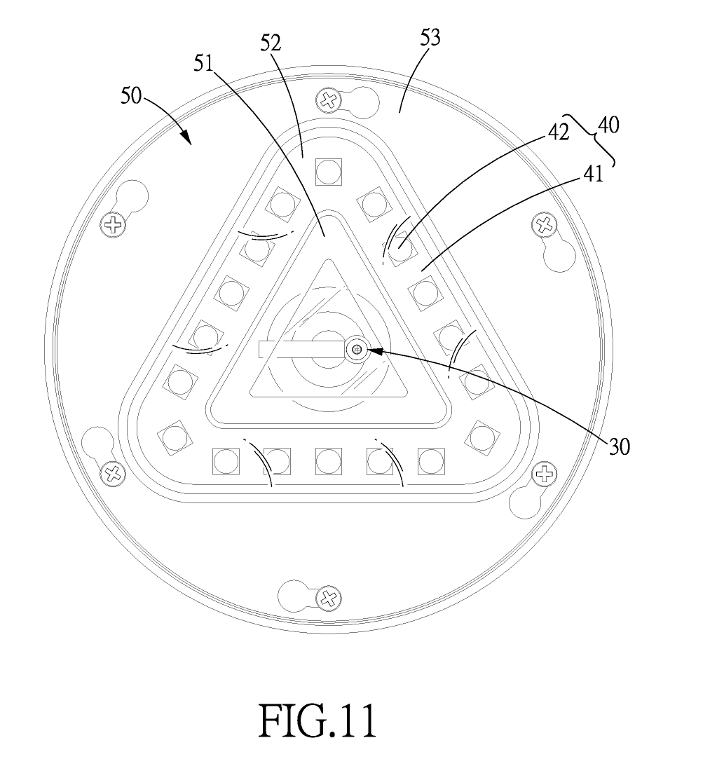

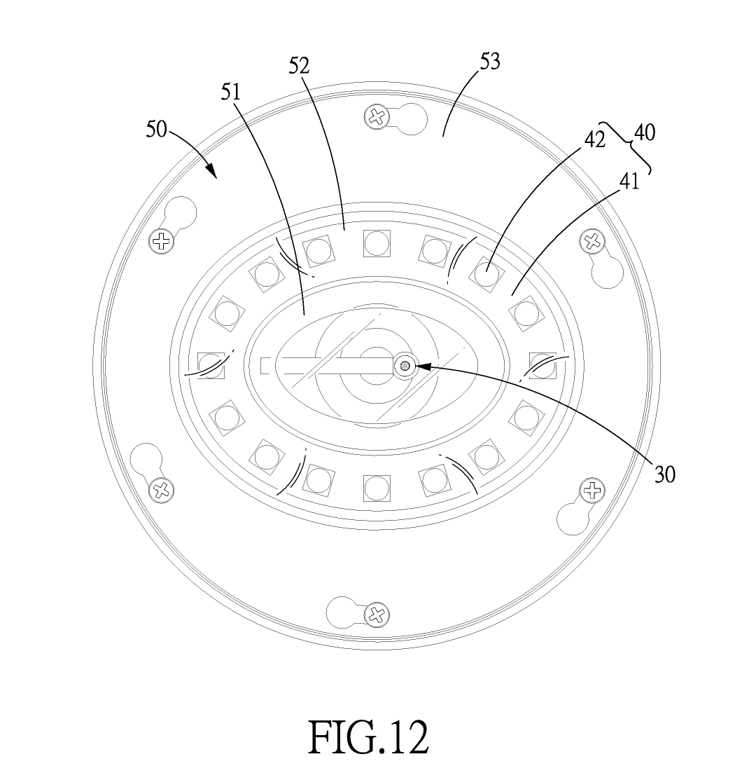

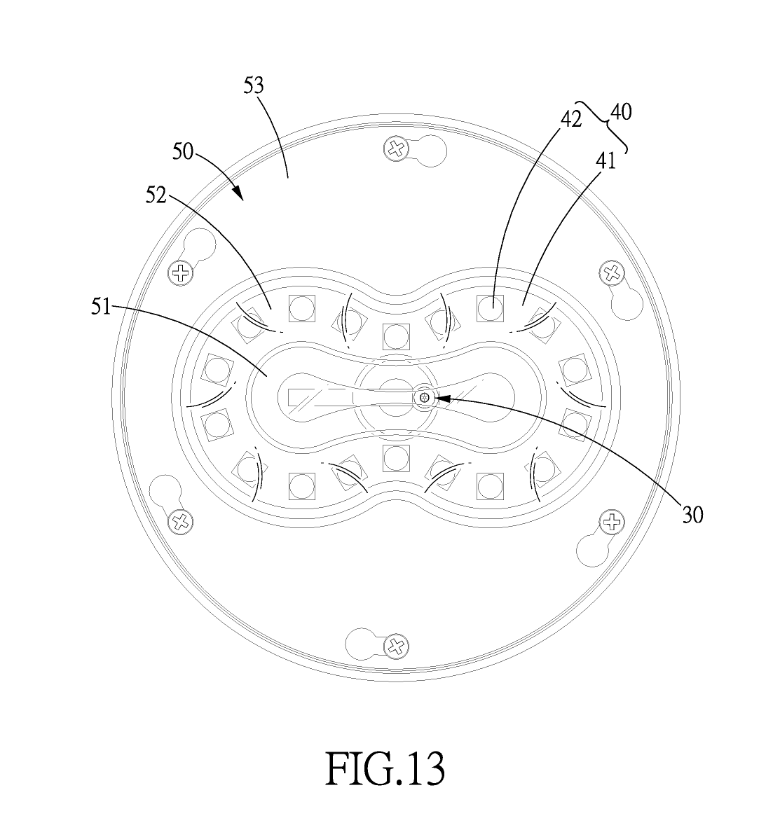

The light emitting elements 42 of the light emitting unit 40 are annularly arranged in a closed configuration, and the lens portion 52 is also correspondingly shaped in the same closed configuration, therefore, the light emitting unit 40 can always fit in the same optical element 50 no matter how the number of the light emitting element 42 changes, as shown in FIG. 4. The configuration (pattern) of the lens portion 52 and the configuration that the light emitting elements 42 are arranged are limited to the circle configuration, they can also be arranged in a square configuration, as shown in FIG. 8, or in the configuration of a closed track as shown in FIG. 9, or in the configuration of a concave lens, as shown in FIG. 10, or in a triangle configuration as shown in FIG. 11, or in an elliptical configuration as shown in FIG. 12, or in the configuration of a curved circle as shown in FIG. 13. The lens portion 52 is also shaped in the same configuration formed by the light emitting elements 42.

The optical element 50 can be easily removed via the connecting portion 53, then the light emitting unit 40 can be removed from the another end of the elastic clamping unit 30, so that the light emitting unit 40 can be easily replaced or removed. Besides, the light emitting unit 40 can always fit in the same optical element 50 no matter how the number of the light emitting element 42 changes, since the configuration in which the light emitting elements 42 are arranged is the same as the shape of the lens portion 52 of the optical element 50.

While we have shown and described various embodiments in accordance with the present invention, it is clear to those skilled in the art that further embodiments may be made without departing from the scope of the present invention.

What is claimed is:

1. A light emitting device comprising:
a lamp holder;
a light emitting unit removably disposed on the lamp holder, and including a plurality of light emitting elements disposed on a circuit board and arranged in a closed configuration;
an optical element with a lens portion and a connecting portion and removably disposed on the lamp holder, the lens portion being formed in a closed configuration which is the same as the closed configuration formed by the light emitting elements, and the lens portion being aligned with the light emitting elements.

2. The light emitting device as claimed in claim 1, wherein the light emitting elements are spaced apart from one another.

3. The light emitting device as claimed in claim 1, wherein the light emitting elements are seamlessly connected to one another.

4. The light emitting device as claimed in claim 1, wherein the light emitting elements are annularly arranged in a circle configuration, and the lens portion is also formed in the shape of a circle configuration.

5. The light emitting device as claimed in claim 1 further comprising an elastic clamping unit which is disposed on the lamp holder and has one end fixed to the lamp holder, the circuit board includes a hole, the elastic clamping unit has another end passed through the hole and elastically pressed against the circuit board, the optical element includes a cover portion with an inner space and an inner surface, and the elastic clamping unit is received in the inner space of the optical element.

6. An optical element used in a light emitting device comprising a lens portion and a connecting portion, and the lens portion being formed in a closed configuration.

7. The optical element used in the light emitting device as claimed in claim 6 further comprising a cover portion with an inner space.

8. The optical element used in the light emitting device as claimed in claim 6, wherein the lens portion is shaped in a circle configuration, or a square configuration, or in the configuration of a closed track, or in the configuration of a concave lens, or in a triangle configuration, or in an elliptical configuration, or in the configuration of a curved circle.
